(19) United States
(12) Patent Application Publication
(10) Pub. No.: US 2015/0286075 A1
(43) Pub. Date: Oct. 8, 2015

(54) 3D Tracer

(71) Applicant: MANAGING INNOVATION AND TECHNOLOGY, Irving, TX (US)

(72) Inventors: Hoa Nguyen, Irving, TX (US); George Deprez, Irving, TX (US); Sameer Cholayil, Irving, TX (US); Ted Roepsch, Irving, TX (US); James Holbrook, Irving, TX (US); Brian Doan, Irving, TX (US); Jorge Bermeo, Irving, TX (US)

(73) Assignee: MANAGING INNOVATION AND TECHNOLOGY, Irving, TX (US)

(21) Appl. No.: 14/247,267

(22) Filed: Apr. 8, 2014

(51) Int. Cl. G02C 13/00; G05B 19/04; H04N 5/232

(52) U.S. Cl. CPC G02C 13/003; H04N 5/23222; G05B 19/0405; G05B 2219/23012

(57) ABSTRACT

Described herein is an apparatus and method for characterizing the precise dimensions of a pair of eyeglass frames, including that of the internal setting groove, through a non-mechanical measurement mechanism. The intended spatial resolution in all three orthogonal axes (x, y, & z) is better than 50 microns (millionths of a meter).

### TECHNICAL FIELD OF THE INVENTION

The present invention relates to a machine which determines ophthalmic frame groove dimensions in up to three axes of a metal or plastic optical frame so that a ophthalmic lens can be cut with a precise bevel allowing the lenses to individually fit inside the eye wire with their optical centers aligned to a user's pupil positions with minimal frame distortion.

### BACKGROUND OF THE INVENTION

Existing techniques to measure eyeglass frame dimensions employ a mechanical stylus. See, for example, US20140020254, US20130067754, and U.S. Pat. No. 8,578,617, which all describe mechanical contact methods to measure the shape and dimensions of the frame needed to fit the glass. These patents describe measuring the groove of the frame to get information about the shape and dimensions of the frame which assists an eyeglass maker to decide on the dimensions to cut a lens and its bevel to fit a frame.

The problems with these methods include:
a. Measurements with a stylus in the tracer machine at a optician's office location result in errors in the lens cut at a lab which has the cut/edger machine due to calibration errors between the different instruments. The mechanical instrument needs to be calibrated often in the optician's office to ensure accurate measurements.
b. The tracer stylus often falls out of the groove and fails to accurately measure the depth due to groove width or sharp curving turns around the frame corner. The resulting lens may end up with gaps between the frame and the lens in those corners.
c. Frame shapes can be easily distorted, especially thin plastic frames, because the lenses (dummy or actually used) are removed for enabling stylus-based measurement.
d. Frame bending can occur as a result of bevel incorrectly positioned on the lens edge. This results in the frame user feeling that the frame does not look like what he expected while trying on the frame with dummy lenses.
e. Additional time and shipping charges result from the need to ship frames to the remote lab for tracing, cutting, edging and fitting of the lens to the selected frame. Any delay can impact frame scheduling, sometimes for multiple opticians, piling up in the labs for measurement and processing.

### SUMMARY OF THE INVENTION

The present invention eliminates a physical stylus tracing the lens shape by using an imaging system to create a computer model, and then using that model to determine how a lens should be best cut to fit the frame.

A computer model of an eyeglass frame lens groove is created in a two-stage process, which is then used to manufacture the lenses. A microscopic camera is used to track a frame's lens groove and provide data for the computer frame model. A lighting system is designed specifically to assist the camera to create images which the programmed computer can use to find frame and groove contour lines.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts.

FIG. 1A shows the front view of a typical pair of eyeglass frames.

FIG. 1B shows an orthogonal side view of a typical pair of eyeglass frames shown in FIG. 1A.

FIG. 1C shows the top view of a typical pair of eyeglass frames shown in FIG. 1A, showing the significant degree of curvature (wrap) associated with the frames. It also shows the curve of the front face of the lens, also known as the “Base Curve”. The base curves are typically standard values.

FIG. 1D-1F show an example of a frame-groove imaging and curve-fitting process. FIG. 1D shows the captured imaging data of the frame's upper and lower surface, and contour lines of the lens grove. FIG. 1E shows the imaging data after a curve-fitting adds missing information. FIG. 1F shows the Groove Width 37 and Location 39 of the Groove 27 with respect to the frame edges. Tracking this distance allows a more precise determination of the bevel of the lens so it matches the Frame 11 better than in the prior art.

FIG. 2A is a block diagram of a first embodiment of the invention, referred to as the Imaging Method, consisting of a first Frame Measurement stage, and a second Grove Measurement stage.

FIG. 2B is a block diagram of a second embodiment of the invention referred to as the Mechanical Touch Probe Method.

FIG. 3A shows an orthogonal view of the Frames 11 and Camera 13 used in the Imaging Method acquiring a full field-of-view front Macro-Image 15.

FIG. 3B shows the Imaging System 17 positioned to begin capturing Micro-Images 19 of the Frame 11 using a Camera Mirror 55.

FIG. 3C shows the groove imaging system in relation to a Frame 11 (used to acquire z-axis or depth information for all methods described herein), including the Touch Probe 31, Z-Axis Stage 35 and Touch Probe Retraction Spring 57.

FIG. 4A shows the Imaging method, specifically using the Z-Axis Laser 25 and Laser Camera 26, which determine height of Frame 11 at a number of points on the Frame 11. FIG. 4B shows the Mechanical Touch Probe method, specifically using the Touch Probe 31, Z-Axis Stage 35 and Touch Probe Retraction Spring 57.

FIG. 5 shows the multi-color LED Frame Lighting 41 sheet used for background and foreground zone based illumination, and the Frame Mount 51 apparatus.

FIG. 6 is an orthogonal view of an optional advanced base using a six-axis Hexapod for the Frame Holder Assembly shown in FIG. 5.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently—described systems and methods. The specific embodiments discussed herein are, however, merely illustrative of specific ways to make and use the disclosure and do not limit the scope of the disclosure.

Two measurement methods are disclosed in the present invention: (1) an Imaging Method; (2) a Mechanical Touch Probe Method. In both of these methods, a computer model of an eyeglass frame lens groove is created in a two-stage process, which is then used to manufacture the lenses. The two methods differ only in their first stage, in which the initial data to drive a microscopic camera is collected.

These methods capture multiple images from the interior of an eyeglass lens grove; the computer processes the images to identify, measure and store the features of the frame's lens groove. In the current embodiment, a user removes a lens from the left side of the frames to allow for the frame groove can be measured and modeled. This method can be used to generate a standalone three-dimensional model generation of the lens that is cut and beveled.

The Imaging Method uses a Z-Axis Laser 25 to determine the vertical dimension (z-axis) of the top of a Frame 11 as it is mounted in the invention, as it creates a computer model of the Frame 11 and designs the lens to properly fit the Frame 11.

The Mechanical Touch Probe method uses a Touch Probe to find the vertical dimension, rather than a camera and laser, to correct the computer model for the frame's curvature,

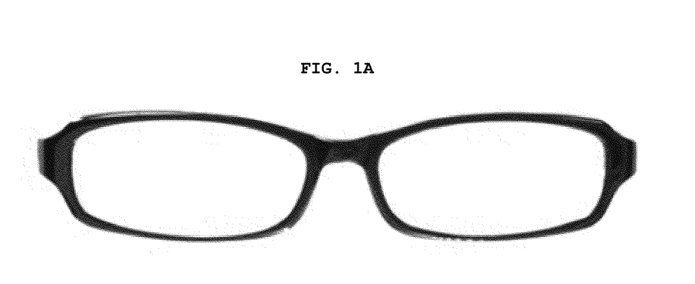

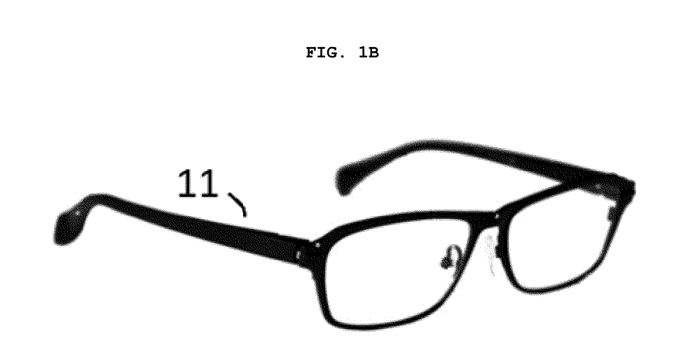

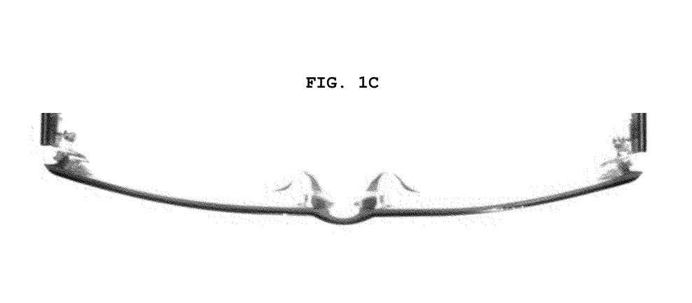

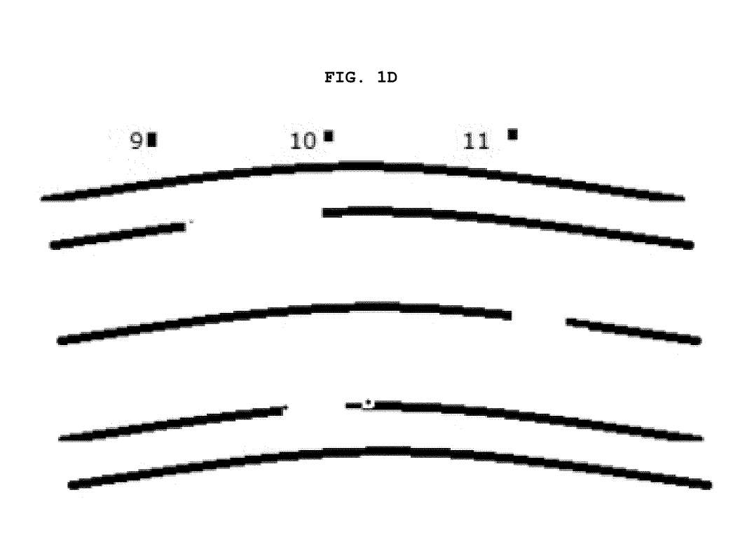

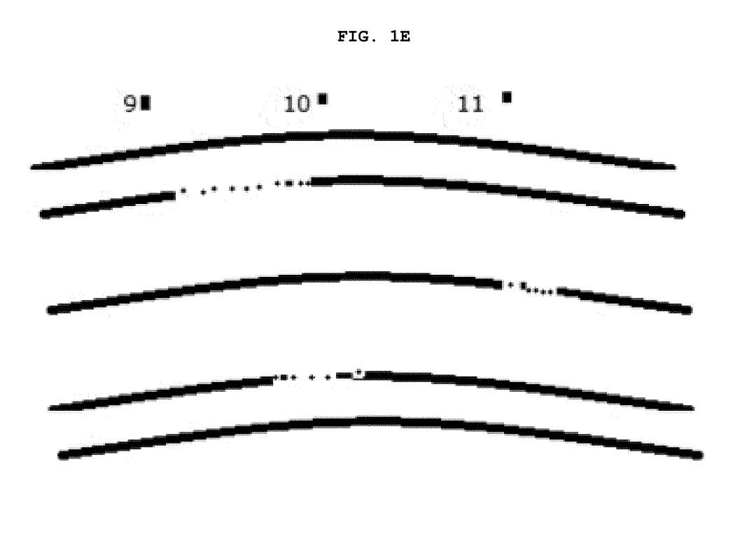

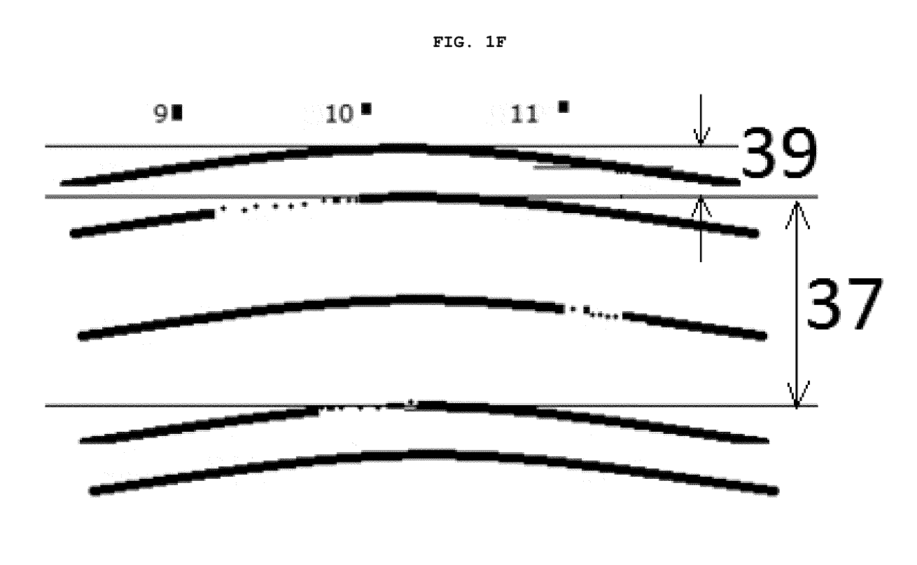

The objective of the invention is to characterize the precise shape of a pair of eyeglass frames, including that of the internal groove (see FIG. 1A-1D), to a spatial resolution of better than 50 microns in all three physical directions, referred to as “x”, “y”, and “z”.

The imaging system based method is performed in two stages. The first stage measures the dimensions of a pair of glasses. The second stage focuses on the frame's inside grooves in which a lens fits and is held in place. Together, these processes produce a data set sufficient to cut the real lens and form the proper bevel on its edge.

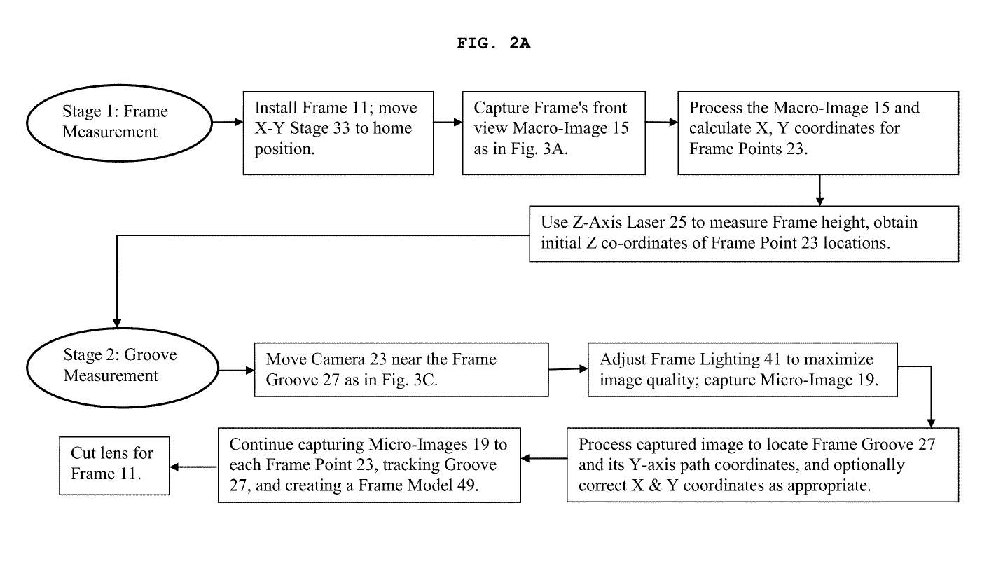

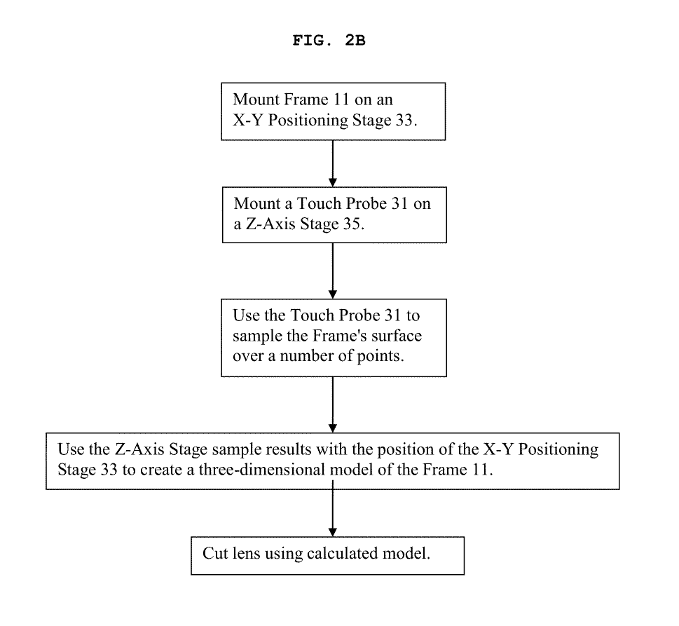

One embodiment of the first stage is the Imaging System, shown on FIG. 2A, in which a two-step imaging system is used to capture images of the frames and dummy lenses. The first step is to create an image of the entire Frame 11, referenced as the Macro-Image 15. Then the camera approaches the Frame 11 and creates images taken very close, known as Micro-Images 19, generating highly detailed images from with a microscopic field of view. From these detailed Micro-Images 19, the profiles of the Frame 11 and Dummy Lenses 21 are constructed in detail.

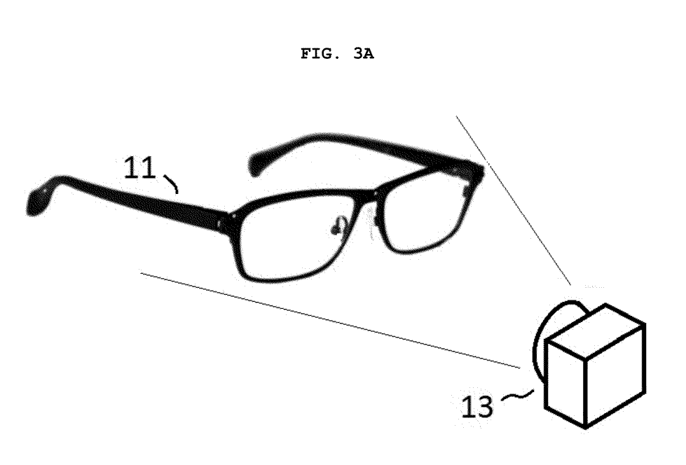

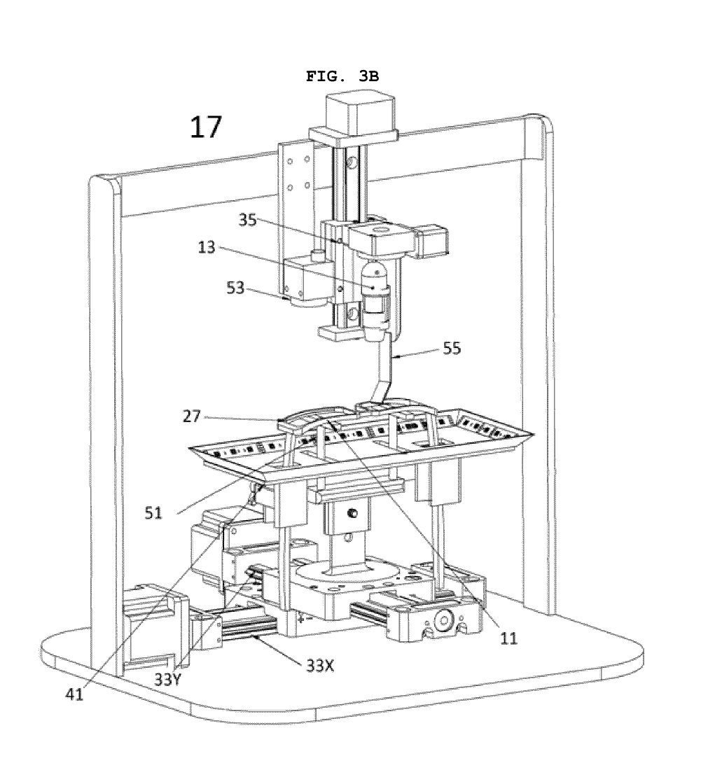

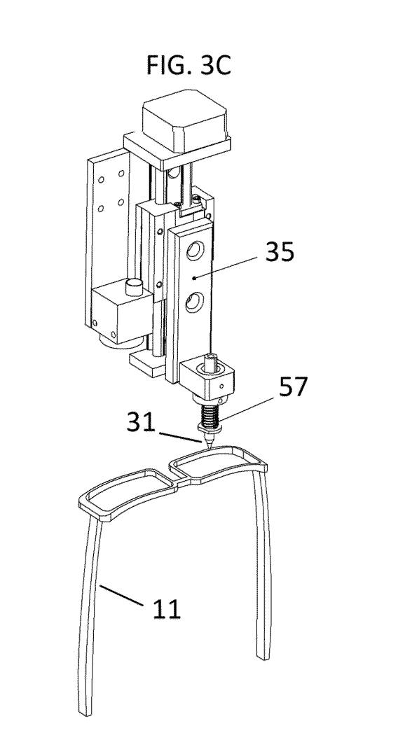

In the Frame Measurement stage of the Imaging Method, the eyeglass Frame 11 is positioned by small steps in the x-y plane with a computer-controlled linear X-Y Stage 33, as shown in FIG. 3B. Commercially available stages may be positioned within 2 microns (millionths of a meter). A Camera 13 creates a full front Macro-Image 15, as shown in FIG. 3A. This image is processed to determine Frame Points 23, coordinates of locations around the Frame 11 and Lenses 21 where the Camera 13 should create microscopic images to add detail in the Frame Model 49.

In the current embodiment, the algorithm overlays places two lines horizontally across the lens locations on the Macro-Image 19, and two vertically over both lens areas. The algorithm determines the x- and y-coordinates of points close to the boundary of the Frame lens. In this embodiment, this process creates eight sets of coordinates, called Frame Points 23.

The Camera 13 is then placed in a position close to the frame to capture Micro-Images 19 in front of each Frame Point, as shown in FIG. 3B. In this stage, the invention lowers a Camera 13 and Mirror 55. The Camera 13 captures images of the reflection on the Mirror 55, which is positioned toward the Frame Groove 27. During this process, the Frame Lighting 41 is automatically adjusted to generate the most visible contour lines in the in the image.

These Micro-Images 19 are recorded, and any mismatch between expected coordinates is used to correct initially collected coordinate data. The Frame Groove 27 is thereby tracked in real time as the Camera sweeps in a full circle, tracking the Groove 27 during the sweep, and collecting its modeling data.

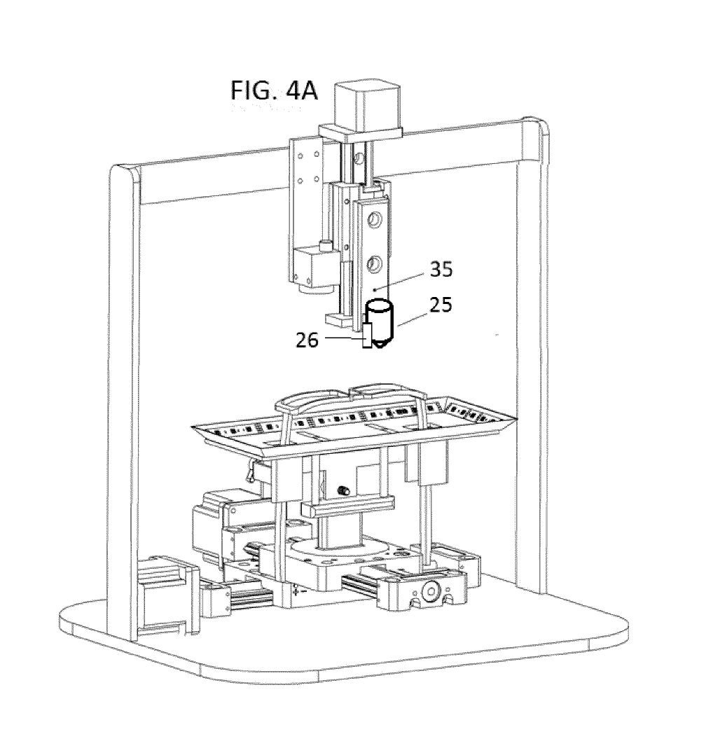

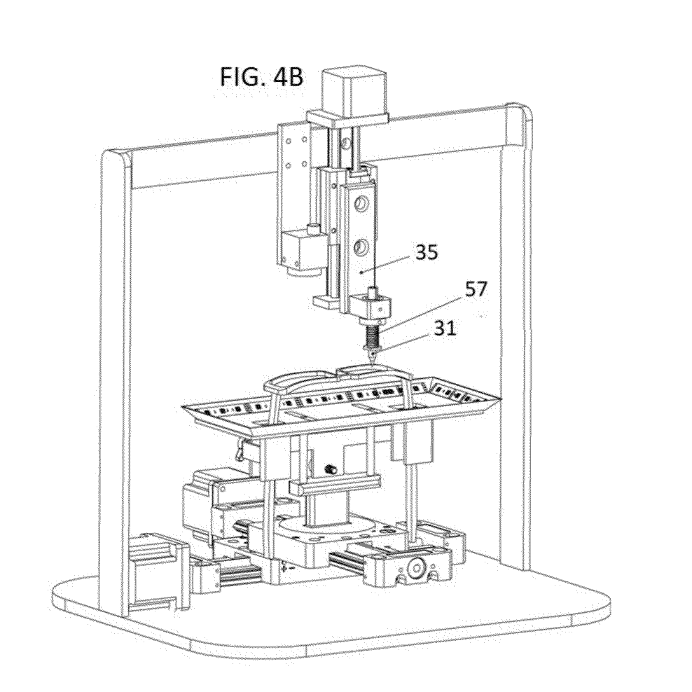

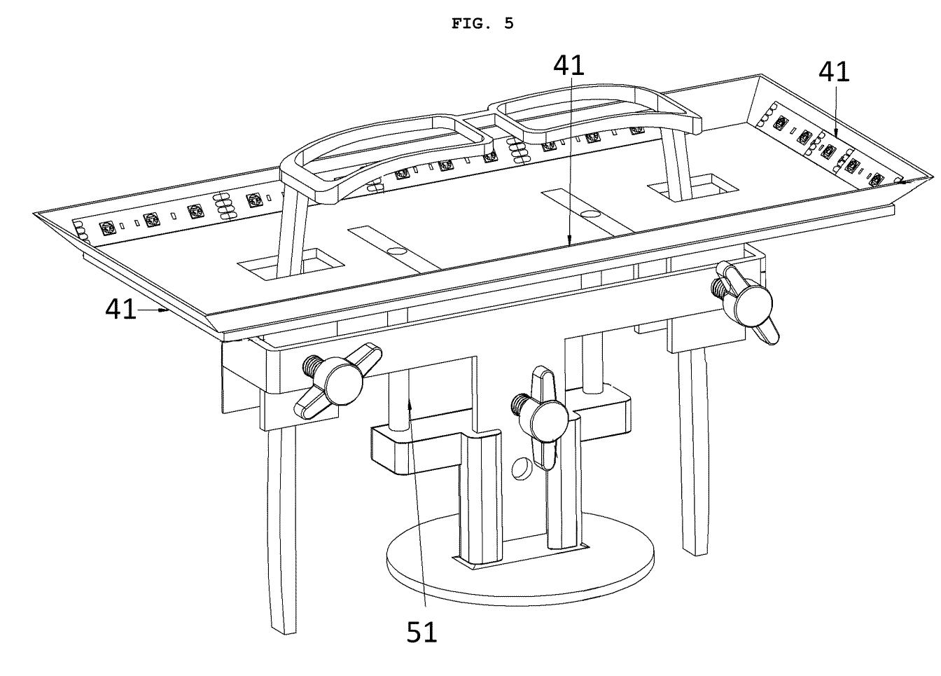

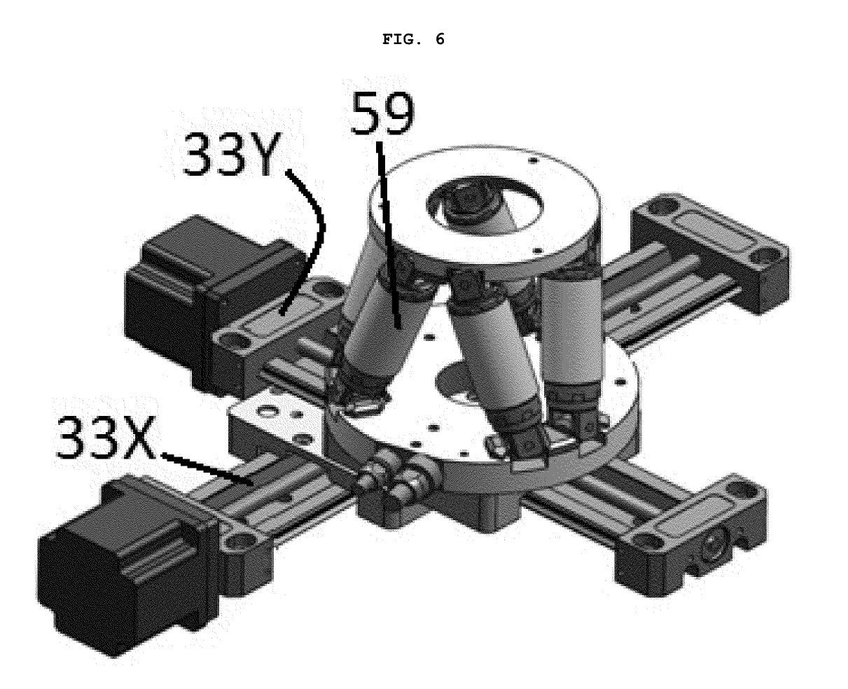

The Micro-Images 19 are taken at a constant distance from the Frame 12 and lens. This is necessary to keep the pixel scale the same in each Micro-Image 19. The constant distance is maintained by Z-Axis Stage 35. Its data may be supplied either by the Mechanical Touch Probe Method, shown in FIG. 4, or the Groove Measurement (Image Method), shown in FIG. 3C.

By applying established and proprietary image processing algorithms, the exact coordinates of points on the boundary of the Frame 11 and Lens 21 may be determined to better than one-micron accuracy in any dimension.

For the Groove Measurement (stage 2), the Camera 13 must have miniature imaging capability system.

This imaging system is rotated with the frame in series of steps. A series of Micro-Images, close-up photos, is taken over a full 360 degrees. The steps can be as little as two microns, depending on the precision of the encoders used on each positioning stage

The Micro-Images are processed to determine the thickness of the groove and its path in the x-y plane. This process also gives the z-axis data with respect to the frame scan in stage one.

As shown in FIG. 4B, the Mechanical Touch-Probe Method is used to collect z-axis depth data over the Frames 11. It uses a commercially-available linear positioning Z-Axis Stage 35 that can measure changes in height with micron accuracy.

To initiate the Mechanical Touch-Probe Method, the eyeglass frames are mounted on a high-accuracy X-Y Stage 33. The probe is mounted on a Z-Axis Stage 35.

The Frame Point 23 position data from the Imaging Method (described above) is used to position the probe. The probe samples the depth of the frame at each of the strategic Frame Points 23. These measurements characterize the profile of the Frame 11.

The method disclosed assumes that the invention's user has no access to factory construction data of the eyeglass Frames 11. However, if this data is available, then it provides significant data to begin a successful model, including the ‘A’ and ‘B’ industry dimensions of lens height and depth.

The current embodiment of the method described is typically performed on the left lens, and a dummy lens is kept in the right lens Frame Groove 27. This allows the user to detect if a dummy lens 27 is missized or misshapen by comparing the examination results of the method on the left side of the frame with the expected shape found on the right, during the first stage of the process, using the Macro-Image.

The current invention also uses a color and intensity controllable light array with multiple independent zones to improve contrast, front and back lighting in the area of interest, when different types of frame materials, like metal, plastic, transparent plastic, translucent plastic or rimless frames are measured in the same apparatus. This allows easy detection of edges and groves under a variety of material conditions.

### LEGEND

Frame 11
Camera 13
Macro-Image 15
Imaging System 17
Micro-Image 19
Lens 21
Frame Point 23
Z-Axis Laser 25
Laser Camera 26
Frame Groove 27
Touch Probe 31
X-Y Stage 33
X-Stage 33X
Y-Stage 33Y
Z-Axis Stage 35
Groove Width 37
Groove Position 39
Frame Model 49
Frame Lighting 41
Frame Mount 51
Z-Stage Encoder 53
Mirror 55
Touch Probe Retraction Spring 57
Hexapod 59

The inventor claims:

1. A method for modeling eyeglass frames to determine the proper cut of an optical lens, comprising;
a. mounting an eyeglasses frame in a positioning x-y stage with the lens' frames in an x-y plane horizontal to the floor, with the temples directed downward;
b. creating a macro-image, an image from above the frame which captures the entire front view of the frame;
c. using the macro-image to construct a set of coordinates that denote locations at which a camera should capture detail-revealing images taken close to the frame, particularly the frame groove that holds a lens in place;
d. capturing micro-images at each coordinate previously calculated;
e. developing a model of the frame with the captured images;
f. providing instructions to enable a user to manufacture lenses which fit the eyeglass frame.

2. The method as in claim 1, with the additional step: controlling precisely the camera height above the frame such that the images are all taken from a consistent height above the frame, taking the curve of the frame into account;

3. The method as in claim 2, further limited:
controlling precisely the camera height above the frame with a flexible feeler coupled to a laser point height detector above the frame, such that the images are all taken from a consistent height, taking the curve of the frame into account;

4. The method as in claim 1, further limited step a):
mounting an eyeglasses frame in a positioning x-y stage with the lens' frames in an x-y plane horizontal to the floor, with the temples directed downward, and in which dummy lenses may be installed in left or right lens positions.

5. The method as in claim 1, further limiting step d):
capturing micro-images at each coordinate previously calculated by using linear stages to move the frames along the x- and y-axis, as well as a surface rotation element;

6. The method as in claim 5, further limiting step d):
capturing micro-images at each coordinate previously calculated by using linear stages to move the frames along the x- and y-axis, as well as a surface rotation element, and encoders to control the distance moved.

7. The method of claim 1, with the additional limitation that the microscopic camera is positioned inside a frame's lens area so that it can scan and measure the frame groove in the imaging system's x, y and z axes and the thickness of the groove by rotation only;

8. The method of claim 1, with the additional step of rotating a microscopic camera inside a frame's lens area so that it can scan and measure the frame groove in the imaging system's x, y and z axes and the thickness of the groove by approaching a Frame Point and moving the camera close to the frame groove, and tracking the groove while capturing the micro-images.

9. The method of claim 1 step of arriving at the groove height value so that a bevel can be placed on the lens. The groove height can be obtained from A and B values of the frame specification data put in by the user and z-dimension found during the micro-image capture process.

10. The method of claim 1, with the additional limitation that the algorithm assumes vertical distances provided by industry specifications of a Frame.

11. The method disclosed in claim 1, with the additional step of changing the settings on a multi-zone, independently controllable lighting system which color and intensity can be controlled from a computer to provide appropriate foreground and background lighting for the area under measurement using the imaging systems.

12. An apparatus comprising a computer and software running on the computer to coordinate the motion control, imaging system and lighting operation, computing distances and forming cad data for lens cutting and transmitting the cad data converted to optical format VCA to edger machine;

13. The apparatus of claim 12, with the added limitation that the apparatus includes a camera which capture images of the frame grove while oriented downward and operating through a 45° reflecting mirror, all held in position by a shaft attached to a stepper motor that can turn the mirror around its axis
